(19) United States
(12) Patent Application Publication
(10) Pub. No.: US 2008/0139257 A1
(43) Pub. Date: Jun. 12, 2008

(54) Portable electronic device incorporating rheological material

(76) Inventors: Steve X. Dai, Gilbert, AZ (US); Pawitter S. Mangat, Gilbert, AZ (US); Christopher S. Schreiner, Maricopa, AZ (US)

Correspondence Address: INGRASSIA FISHER & LORENZ, P.C. (MOT), 7010 E. Cochise Road, SCOTTSDALE, AZ, 85253, US

(21) Appl. No.: 11/635,413

(22) Filed: Dec. 7, 2006

(51) Int. Cl. H04M 1/00

(52) U.S. Cl. 455/575.1

(57) ABSTRACT

A portable electronic device (32, 50, 60, 90) and method is provided wherein the portable electronic device embodies a flexible structural form that may be made rigid for use. The portable electronic device (32, 50, 60, 90) comprises a housing (10) including a plurality of blocks (12, 82) contiguously positioned between first and second films (14, 16, 84). One of an electrorheological or a magnetorheological material (18, 86) is positioned between each of the plurality of blocks (12, 82). Electronics positioned within the housing (10) include circuitry for applying one of an electric field and a magnetic field to the respective electrorheological and magnetorheological material (18, 86).

### FIELD OF THE INVENTION

The present invention generally relates to portable electronic devices and more particularly to a portable electronic device that embodies a flexible structural form that may be made rigid for use.

### BACKGROUND OF THE INVENTION

The market for personal portable electronic devices, for example, cell phones, personal digital assistants (PDA's), digital cameras, and music playback devices (MP3), is very competitive. Manufacturers, distributors, service providers, and third party providers have all attempted to find features that appeal to the consumer. For example, service providers are continually looking to improve cell phone reception and access to the internet for down loading of information, music, and the like. Third party providers are constantly searching for the additional item that functions well with the manufacturer's product. Manufacturers are constantly improving their product with each model in the hopes it will appeal to the consumer more than a competitor's product. Many times these manufacturer's improvements do not relate directly to the functionality of the product.

The look and feel of personal portable electronics devices is now a key product differentiator and one of the most significant reasons that consumers choose specific models. Consumers are enamored with sleek designs and other customizable features, e.g., cell phone ring tones, on portable electronic devices. These features reflect personal style. From a business standpoint, these outstanding designs (form and appearance) increase market share and margin.

Electronic devices are highly individualized, with users desiring to customize their devices to reflect their personalities and feelings. This desire extends to functionality also.

Portable/wearable electronic devices, e.g., cell phones, typically have solid housing structure made of hard materials which do not conform to the size and shape of a user's body. This often creates ergonomic issues for the user carrying such devices.

Accordingly, it is desirable to provide a portable electronic device that embodies a flexible structural form that may be made rigid for use. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A portable electronic device and method is provided wherein the portable electronic device embodies a flexible structural form that may be made rigid for use. The portable electronic device comprises electronic circuitry including a device for applying one of an electric and a magnetic field and one of an electrorheological or a magnetorheological material responsive to the respective electric or magnetic field.

### BRIEF DESCRIPTION OF THE DRAWINGS

The present invention will hereinafter be described in conjunction with the following drawing figures, wherein like numerals denote like elements, and

FIGS. 1 and 2 are an exemplary embodiment in different configurations;

FIGS. 3 and 4 are different arrangements of an exemplary embodiment of a cell phone incorporating the configuration of FIG. 2;

FIG. 5 is another exemplary embodiment of a cell phone incorporating the configuration of FIG. 2;

FIGS. 6 and 7 are an exemplary embodiment of an electronic device incorporating the configurations of FIGS. 1 and 2; and

FIG. 8 is yet another exemplary embodiment;

FIG. 9 is another exemplary embodiment of an electronic device incorporating the embodiment of FIG. 8.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Electronic devices in accordance with the exemplary embodiments described herein include electrorheological or magnetorheological materials that allow, when the electronic device is not in use, for flexibility to conform to a human body, for example, and for rigidity to stay in a fixed shape or configuration for ease of operation of the device, when the device is in use.

A rheological material, such as an electrorheological or magnetorheological material, is deformable in free standing form, but becomes rigid when subjected to a field, an electric to the electrorheological material or a magnetic field to the magnetorheological material, for example. These materials are fluids made from suspensions of a base fluid and microparticles having a diameter in the range of 0.1 to 100.0 microns. In free standing form, the particles are positioned randomly. In the presence of the respective electric or magnetic field, the particles will line up forming chains due to an induced dipole moment. This positioning of the particles in a chain increases the viscosity and yield stress, thereby changing the material to a more rigid form, such as from a gel to a solid.

Four exemplary embodiments of electronic devices are described herein. In a first exemplary embodiment, the electrorheological or magnetorheological material is positioned between two soft films, forming a front and/or back surface of a cell phone. The front and/or back surface would conform, in its non-rigid state, to the surface in which it is in contact, e.g., a part of the user body such as in a hip pocket. In a second exemplary embodiment, the electrorheological or magnetorheological material is positioned between two soft films, forming a side surface of a cell phone. In the non-rigid state, the phone could be shaped wherein the sides are curved to fit the user's fingers in a handheld position. In a third exemplary embodiment, the electrorheological or magnetorheological material is incorporated in joints, thereby allowing for relative movement of different phone surfaces in the non-rigid state. A fourth embodiment comprises a “chain” of functional electronic blocks separated by the electrorheological or magnetorheological material. In the four embodiments, the electrorheological or magnetorheological material would be placed in a rigid state for operation of push buttons or the like.

Referring to FIG. 1, a front and/or a back surface 10 (of a cell phone housing for example) in accordance with the first and second exemplary embodiment mentioned above, include a plurality of blocks 12 positioned between a first soft film 14 and a second soft film 16. While in describing the exemplary embodiments herein, a cell phone is generally described; however, it should be understood that the invention could be applied to any electronic device, especially those portable devices carried by a user. The blocks 12 may comprise any solid material, but preferably comprise a metal such as aluminum. The first and second soft films 14, 16 preferably comprise a polyimide flex printed circuit board film, but may comprise any material that easily deforms or bends such as silicone rubber. Positioned between the first and second soft films 14, 16 and between each of the plurality of blocks 12 is one of either an electrorheological or magnetorheological material 18.

When in the absence of a respective electric or magnetic field, the electrorheological or magnetorheological material 18 is in liquid form, allowing for the blocks 12 to move in relation to one another. For example, referring to FIG. 2, the surface 10 is curved so that the first and second soft films 14, 16 form arcs of concentric circles. The blocks 12 are now positioned so that a first portion 22 (lower portion as illustrated) of each block 12 is closer to the first portion of an adjacent block, and that a second portion 24 (upper portion as illustrated) of each block 12 is farther from the first portion of an adjacent block. The area 26 containing the electrorheological or magnetorheological material 18 in the non-rigid, liquid state between the first portions 22 of the blocks 12 is smaller, and the area 28 containing the electrorheological or magnetorheological material 18 in the non-rigid, liquid state between the second portions 24 of the blocks 12 is larger. Note that the volume of the total area 26, 28 containing the electrorheological or magnetorheological material 18 does not change. The electrorheological or magnetorheological material 18 comprises any material that is deformable in free standing form, but which becomes rigid when subjected to an electric field such as LID 3354 manufactured by ER Fluid Developments, Ltd or a magnetic field such as VersaFlo™ MR-100 manufactured by Lord Corporation.

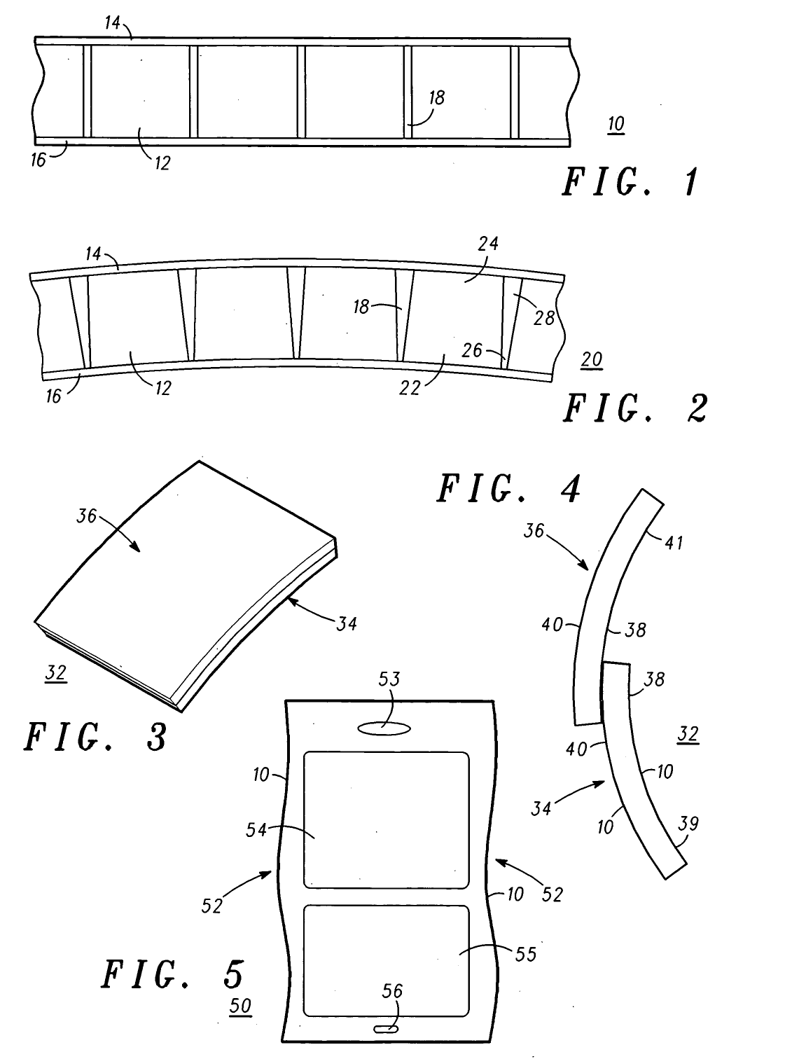

FIGS. 3 and 4 are examples illustrating how the electrorheological or magnetorheological material 18 may be used in a slide cell phone 32 in a closed and open position, respectively. The phone 32 comprises a first (lower) section 34 and a second (upper) section 36. In this particular exemplary embodiment as shown, both a first (front) side 38 of both the first and second sections 34, 36, and a second (back) side 40 have a surface comprising the surface 10 described with reference to FIGS. 1 and 2. It should be understood that an alternate embodiment may comprise only one of the first and second sides 38, 40 incorporating the electrorheological or magnetorheological material 18. The first and second sections 34, 36 slide in a well known manner to allow the first and second sections 34, 36 to move between the closed and open position. In the open position of FIG. 4, a microphone (not shown) may be located on a lower portion. 39 of the front side 38 of the first section 34, and a speaker (not shown) may be located on an upper portion 41 of the front side 38 of the second section 36, for example. In the closed position of FIG. 3, the phone 32 may assume a curved form as shown to fit in a back pocket for example, or any position depending on its position in relation to the surrounding environment. When the cell phone 32 is not in use, the electric or magnetic field would not be selected allowing for the surface 10 to “assume” the contour of the body. When the user desires to make a call, an input such as a button is selected, activating one of the electric or magnetic field, thereby causing the electrorheological or magnetorheological material 18 to become rigid. This prevents the cell phone 32 from changing form when pushing buttons, etc.

FIG. 5 illustrates the second embodiment mentioned above wherein the electrorheological or magnetorheological material 18 is incorporated in the sides 52 of the phone 50. A typical cell phone may include a speaker 53, display 54, input device 55, and microphone 56, but the electrorheological or magnetorheological material 18 may be incorporated with any known portable electronic device.

Referring to FIGS. 6 and 7, a third exemplary embodiment shown in a closed and open position, respectively, comprises an electronic device 60 including first, second, and third sections 61, 62, 63. The electrorheological or magnetorheological material 18 is placed in the hinges 64, 65, 66, 67, with each of the hinges 64, 65, 66, 67 being constructed in accordance with the structure 10 described in FIG. 1. While three sections 61, 62, 63 are shown, it should be understood that the exemplary embodiment may comprise any number of sections greater than one. The electronic device 60 may be folded as shown in FIG. 6 for placing in a stored position such as in a wallet or purse, and then extended as shown in FIG. 7 during normal operation. Electronic communication between each of the sections 61, 62, 63 may be made, for example, wirelessly such as by Bluetooth or by wires (not shown) between each of the sections 61, 62, 63. Each section 61, 62, 63 may comprise, for example, a display, speaker, input device, camera, etc.

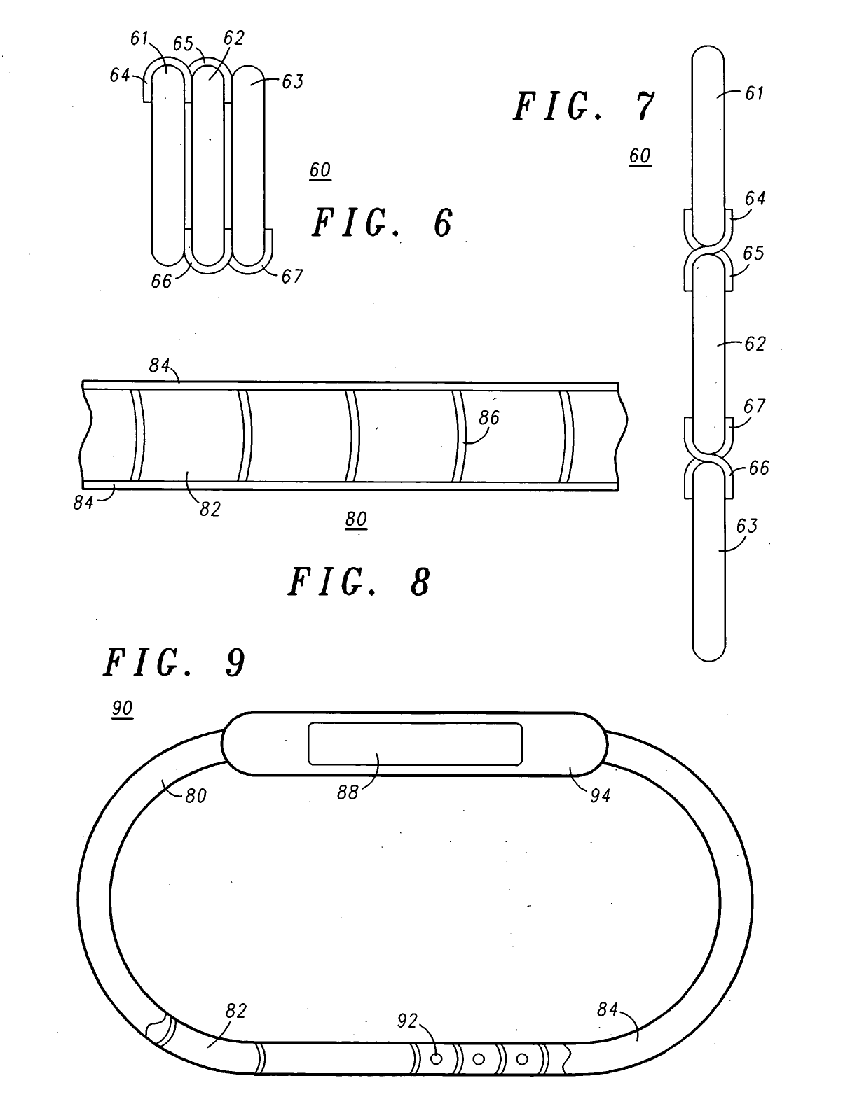

The fourth exemplary embodiment is illustrated in FIGS. 8 and 9. A chain 80 of electronic blocks 82 are positioned within an outer cylindrical surface 84. The electronic blocks 82 comprise various functions of the electronic device 90. For example, a series of electronic blocks 82 in succession may comprise the digits 0-9, which may be selected by pressing a button 92, thereon. The button 92 may alternatively comprise a pressure point for an underlying transducer as known in the art. Other electronic blocks 82 may be for turning the power on or off, and scrolling text on the display 88 contained within a housing 94. One of the buttons 92 may be for activating an electric or magnetic field to cause the electrorheological or magnetorheological material 86 to become rigid for pressing other buttons. During non-use, the electric or magnetic field would be deactivated, allowing for the chain, or necklace, 80 to be flexible. When use of the electronic device 90 is desired, the electric or magnetic field is activated, thereby causing the electronic device 90 to become rigid, making it easier to push buttons on the various electronic blocks 82.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A portable electronic device capable of selectively assuming one of a flexible or a rigid form, comprising:
a rheological material;
electronic circuitry including a device for applying a field to the rheological material, thereby causing the rheological material to change from the flexible form to the rigid form.

2. The portable electronic device of claim 1 wherein the electronic circuitry comprises a mobile communication device.

3. The portable electronic device of claim 1 further comprising:
a plurality of sections including the electronic circuitry; and
a plurality of hinges between each of the plurality of sections, wherein each of the plurality of hinges comprises the rheological material.

4. The portable electronic device of claim 1 wherein the portable electronic device comprises a housing, and the rheological material comprises at least a portion of the housing.

5. The portable electronic device of claim 4 wherein the housing comprises:
first and second flexible layers defining a channel; and
a plurality of blocks positioned within the channel, wherein the Theological material is positioned between each of the plurality of blocks.

6. The portable electronic device of claim 5 wherein the housing comprises opposed sides comprising the first and second flexible layers.

7. The portable electronic device of claim 1 further comprising:
a cylindrical tube having a flexible outer layer defining a channel; and
a plurality of electronic blocks positioned within the channel, the electronic circuitry being contained within the plurality of electronic blocks, wherein the Theological material is positioned between each of the plurality of electronic blocks.

8. The portable electronic device of claim 7 wherein the cylindrical tube comprises at least a portion of one of a bracelet or a necklace.

9. The portable electronic device of claim 1 wherein the rheological material comprises one of an electrorheological and a magnetorheological material.

10. The portable electronic device of claim 1 wherein the field comprises one of an electric and a magnetic field.

11. A portable electronic device, comprising:
a housing;
a rheological material; and
electronic circuitry positioned within the housing and for applying one of an electric and a magnetic field.

12. The portable electronic device of claim 11 wherein the electronic circuitry further comprises a mobile communication device.

13. The portable electronic device of claim 11 further comprising:
a plurality of sections defining the housing and including the electronic circuitry; and
a plurality of hinges between each of the plurality of sections, wherein each of the plurality of hinges comprises the rheological material.

14. The portable electronic device of claim 11 wherein the rheological material comprises at least a portion of the housing.

15. The portable electronic device of claim 14 wherein the housing comprises:
first and second flexible layers defining a channel; and
a plurality of blocks positioned within the channel, wherein the rheological material is positioned between each of the plurality of blocks.

16. The portable electronic device of claim 15 wherein the housing comprises opposed sides comprising the first and second flexible layers.

17. The portable electronic device of claim 11 further comprising:
a cylindrical tube having a flexible outer layer defining a channel; and
a plurality of electronic blocks positioned within the channel, the electronic circuitry being contained within the plurality of electronic blocks, wherein the rheological material is positioned between each of the plurality of electronic blocks.

18. The portable electronic device of claim 17 wherein the cylindrical tube comprises at least a portion of one of a bracelet or a necklace.

19. A method of causing a flexible form of an electronic device, having electronic circuitry positioned therein, to become rigid, comprising:
applying a field to a rheological material integrally positioned with the electronic device.

20. The method of claim 19 wherein the rheological material comprises a housing for the electronic circuitry.

21. The method of claim 20 wherein the housing comprises at least one film encasing a plurality of blocks separated by the rheological material.

22. The method of claim 20 wherein the electronic circuitry is positioned within a plurality of housings and the rheological material comprises hinges between each of the plurality of housings.
